(19) United States
(12) Patent Application Publication
(10) Pub. No.: US 2011/0084992 A1
(43) Pub. Date: Apr. 14, 2011

(54) ACTIVE MATRIX DISPLAY APPARATUS

(75) Inventor: Shinichi Ishizuka, Mitaka (JP)

(73) Assignee: PIONEER CORPORATION, Kawasaki-shi, Kanagawa (JP)

(21) Appl. No.: 12/994,079

(22) PCT Filed: May 23, 2008
(86) PCT No.: PCT/JP2008/059550

§ 371 Date: Nov. 22, 2010

(51) Int. Cl. G09G 5/10

(52) U.S. Cl. 345/690

(57) ABSTRACT

A display apparatus comprises an average luminance calculating unit that calculates average luminance of a display screen based on a video signal; and a drive voltage adjuster that adjusts a drive voltage of drive transistors each driving a light-emitting element provided in a pixel unit according to the calculated average luminance.

### TECHNICAL FIELD

The present invention relates to a display apparatus including active elements for driving light-emitting elements such as EL (electroluminescent) elements or LEDs (light-emitting diodes) and particularly to a display apparatus including thin film transistors (TFTs) as active elements.

### BACKGROUND ART

TFTs are widely used as active elements for driving an active matrix display such as an organic EL display or a liquid crystal display. FIG. 1 shows an example equivalent circuit of a drive circuit for an organic electroluminescent element (OEL) or an organic light-emitting diode (OLED) 100 for one pixel PLi,j.

Referring to FIG. 1, this equivalent circuit includes two p-channel TFT 101, 102 that are active elements, and a capacitor (Cs) 104. A scan line Ws is connected to the gate of the selecting transistor 101; a data line Wd is connected to the source of the selecting transistor 101; and a power supply line Wz for supplying a constant supply voltage Vdd is connected to the source of the drive transistor 102. The drain of the selecting transistor 101 is connected to the gate of the drive transistor 102, and a capacitor 104 is formed between the gate and the source of the drive transistor 102. The anode and the cathode of the OEL 100 are respectively connected to the drain of the drive transistor 102 and ground potential (or common potential).

When a selecting pulse is applied to the scan line Ws, the selecting transistor 101 as a switch is turned on so as to render it conductive between its source and drain. At this time, a data voltage is supplied from the data line Wd through the selecting transistor 101 between the source and the drain and is stored in the capacitor 104. Because the data voltage stored in the capacitor 104 is applied between the gate and source of the drive transistor 102, a drain current Id corresponding to the gate-to-source voltage Vgs of the drive transistor 102 flows and is supplied to the OEL 100 to emit light.

In the active matrix display, by supplying a data signal corresponding to input video data to each pixel PLi,j via the data line while the selecting pulse (scan pulse) being applied sequentially to the scan lines, an image is displayed.

For the active matrix display, for example, Reference 1 discloses imparting a peak luminance characteristic to suppress white luminance to a low level to video of which the entire screen is bright. Specifically, it is disclosed that using the fact that the potential difference between the input end potential and the terminal end potential of the power supply line in a display apparatus varies according to the screen luminance, the potential on the other end of the data-holding capacitor, one end of which is connected to the gate of the drive transistor, is controlled according to the potential difference (i.e., image luminance), thereby imparting the above-mentioned peak luminance characteristic.

As such, for the active matrix display, it is becoming a very important capability to reduce power consumption from the viewpoint of saving energy, suppressing heat generation, making the apparatus thinner, and so on. Hence, providing a display apparatus of low power consumption is strongly desired.
Reference 1: Japanese Patent Application Laid-Open Publication No. 2006-189552 (p. 19, FIGS. 1, 2)

### DISCLOSURE OF THE INVENTION

### Problem to be Solved by the Invention

One example of the problems to be solved by the present invention is the above defect in the conventional art. An object of the present invention is to provide a display apparatus of low power consumption that imparts a peak luminance characteristic to suppress white luminance to a low level to video whose entire screen is bright.

### Means for Solving the Problem

According to the present invention, there is provided a display apparatus which has an active matrix type of display panel comprising a plurality of pixel units each having a light-emitting element and a drive transistor driving the light-emitting element, a scan drive unit for sequentially scanning scan lines of the display panel, and a data drive unit for supplying a data signal based on a video signal to a control electrode of each of the drive transistors in association with scanning by the scan drive unit, the display apparatus comprises a capacitor provided in each of the plurality of pixel units to hold the data signal, a first terminal of the capacitor being connected to the control electrode of the drive transistor; a capacitor voltage generating unit which generates a capacitor voltage to be applied to a second terminal of each of the capacitors; an average luminance calculating unit which calculates average luminance of a display screen based on the video signal; and a drive voltage adjuster which adjusts a drive voltage of the drive transistors according to the average luminance.

### BRIEF DESCRIPTION OF DRAWINGS

FIG. 1 shows an example equivalent circuit of a conventional light-emitting element drive circuit;

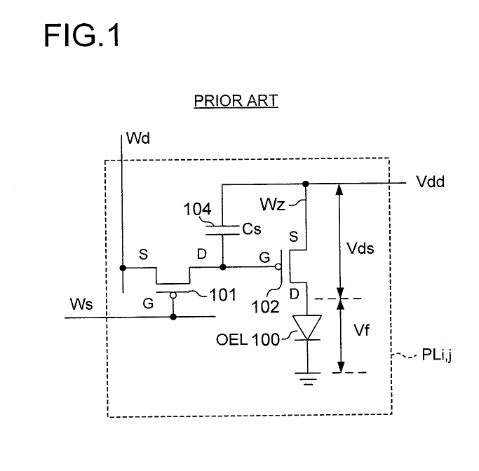

FIG. 2 shows a display apparatus using an active matrix display panel according to a first embodiment of the present invention;

FIG. 3 shows a pixel unit PL_{j,i} associated with data line Xi and scan line Yj from among a plurality of pixel units PL_{1,1} to PL_{m,n};

FIG. 4 is a graph showing schematically a relationship of a drive voltage VD of a drive transistor against a calculated APL value;

FIG. 5 shows the forward voltage (Vf) of an EL element and a drain-source voltage Vds;

FIG. 6 shows a display apparatus using an active matrix display panel according to a second embodiment of the present invention;

FIG. 7 shows a pixel unit PL_{j,i} of a display panel according to a third embodiment of the present invention;

FIG. 8 shows the ON/OFF states of switches SW1 to SW3 of FIG. 7;

FIG. 9 shows a pixel unit PL_{j,i} of a display panel according to a fourth embodiment of the present invention;

FIG. 10 shows a relationship of the drive voltage VD of a drive transistor against the APL value;

FIG. 11 shows a display panel having a black level adjusting circuit according to a fifth embodiment of the present invention; and

FIG. 12 shows a relationship of a black level voltage BL against the APL value.

### DETAILED DESCRIPTION OF THE INVENTION

Embodiments of the present invention will be described below in detail with reference to the drawings. The same reference numerals are used to denote substantially equivalent parts throughout the figures cited below.

### First Embodiment

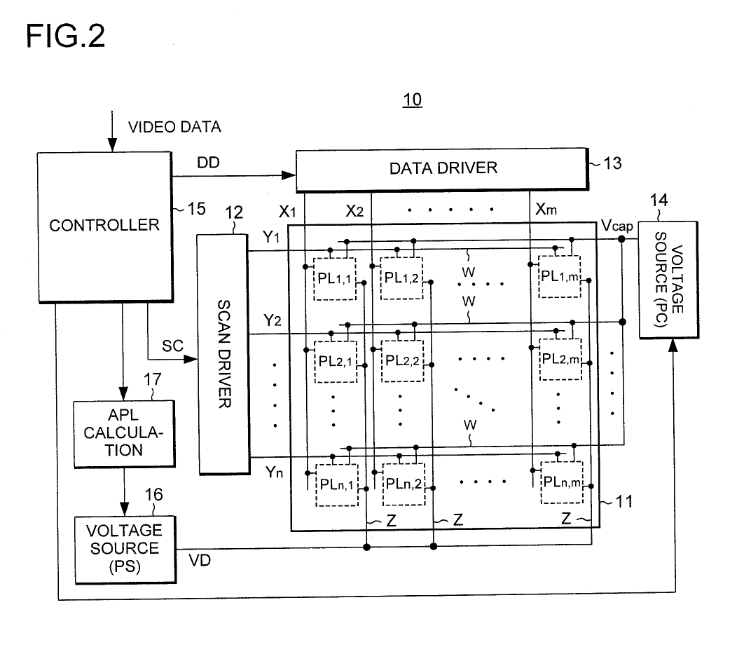

FIG. 2 shows a display apparatus 10 using an active matrix display panel according to a first embodiment of the present invention. The display apparatus 10 comprises a display panel 11, a scan driver 12, a data driver 13, a capacitor voltage source (PC) 14, a controller 15, a light-emitting element drive voltage source (PS) 16, and an average luminance calculating unit (hereinafter also referred to as an APL calculating unit) 17.

The display panel 11 is an active matrix type of display panel comprising “n” rows and “m” columns of pixels, where “m” and “n” are integers greater than or equal to two, and has a plurality of data lines X1 to Xm (Xi; i=1 to m) arranged parallel, a plurality of scan lines Y1 to Yn (Yj; j=1 to n) arranged parallel, and a plurality of pixel units PL_{1,1} to PL_{n,m}. The pixel units PL_{1,1} to PL_{n,m} are arranged at the intersections of the data lines X1 to Xm and the scan lines Y1 to Yn and all have the same configuration.

Further, as described in detail later, the pixel units (or pixel circuits) PL_{1,1} to PL_{m,n} are connected to a light-emitting element drive voltage line (hereinafter simply referred to as a drive voltage line) Z and a capacitor voltage line W.

Note that in this embodiment, description will be made taking as an example the case where the display panel 11 is a monochrome display panel and where each of the pixel units constitutes one pixel.

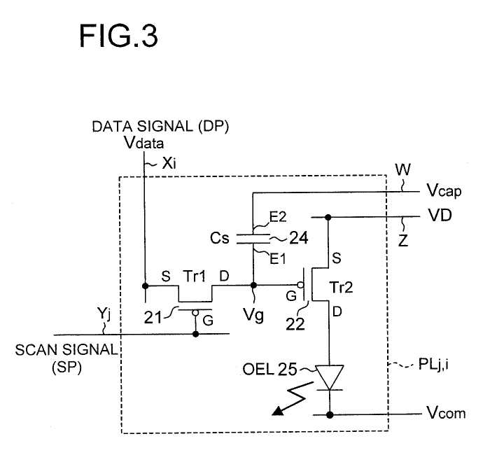

FIG. 3 shows a pixel unit associated with data line Xi (i=1, 2, . . . , m) and scan line Yj (j=1, 2, . . . , n) from among the plurality of pixel units (pixel circuits) PL_{1,1} to PL_{m,n} of the display panel 11. That is, the pixel unit PL_{j,i} is connected to the data line Xi and the scan line Yj, and more specifically, comprises TFTs (thin film transistors) 21, 22 that are respectively a selecting transistor (Tr1) and a drive transistor (Tr2), a data-holding capacitor (Cs) 24, and an organic EL (electroluminescent) light-emitting element (OEL) 25. The selecting transistor 21, the drive transistor 22, and the capacitor 24 constitute a drive circuit for the light-emitting element (EL element) 25. Note that description will be made below taking as an example the case where the two TFTs 21, 22 are P-channel TFTs.

The gate of the selecting transistor (Tr1) 21 is connected to the scan line Yj, and its source is connected to the data line Xi. The drain of the selecting transistor 21 is connected to the control electrode (i.e., gate) of the drive transistor (Tr2) 22. The source of the drive transistor (Tr2) 22 is connected to the drive voltage line Z so that a drive voltage VD (a variable voltage) is supplied thereto from the drive voltage source (PS) 16. The drain of the drive transistor (Tr2) 22 is connected to the anode of the EL element 25. The cathode of the EL element 25 is connected to a potential Vcom common to the plurality of pixel units (pixel circuits) PL_{1,1} to PL_{m,n}, for example, ground potential (Vcom=0).

In the present embodiment, one end of the capacitor (Cs) 24 (a first terminal; electrode E1) is connected to the gate, that is the control electrode, of the drive transistor 22 (and to the drain of the selecting transistor 21), and the other end thereof (a second terminal; electrode E2) is connected to the capacitor voltage source (PC) 14 via the capacitor voltage line W. The connection is made such that a capacitor voltage Vcap (a fixed voltage) is applied to the capacitor (Cs) 24 associated with the scan line Yj from the capacitor voltage source (PC) 14 via the capacitor voltage line W.

The scan lines Y1 to Yn of the display panel 11 are connected to the scan driver 12, and the data lines X1 to Xm are connected to the data driver 13. The controller 15 generates a scan control signal SC and a data control signal DD to gradation-drive control the display panel 11 according to an input video signal. The scan control signal is supplied to the scan driver 12, and the data control signal is supplied to the data driver 13.

The scan driver 12 supplies scan pulses for display on the scan lines Y1 to Yn at predetermined timings according to the scan control signal sent from the controller 15 to perform line sequential scanning.

The data driver 13 supplies respective pixel data signals for the pixel units located on the scan line onto which the scan pulse is being supplied, to the pixel units (i.e., selected pixel units) via the data lines X1 to Xm according to the data control signal sent from the controller 15. For non-light-emitting pixel units, the pixel data signal of a level which does not make their EL element emit light is supplied. In other words, the data signals indicating emission luminance respectively for the pixels are applied via the data lines X1 to Xm in association with the line sequential scanning so as to control the image display of the display panel 11.

The controller 15 controls the entire display apparatus 10, that is, the scan driver 12, the data driver 13, the capacitor voltage source (PC) 14, the light-emitting element drive voltage source (PS) 16, and the APL calculating unit 17.

Next, the circuit operation of the pixel unit PL_{j,i} will be described.

When the scan pulse SP is applied to the j-th scan line Yj to select the scan line Yj, the selecting transistor 21 becomes conductive (i.e., turned on), and a data signal DP (data voltage Vdata) corresponding to the luminance of the pixel unit PL_{j,i} from the data driver 13 is supplied to the gate (i.e., the first terminal; electrode E1) of the capacitor voltage 22 via the selecting transistor 21. Then, the data voltage Vdata is stored in the data-holding capacitor (Cs) 24, and the voltage is held.

Meanwhile, the capacitor voltage Vcap (a fixed voltage) is applied to the second terminal (i.e., electrode E2) of the capacitor 24 via the capacitor voltage line W. Thus, even when the selecting transistor 21 is turned off due to the line sequential scanning, the gate potential of the drive transistor 22 is fixed at the Vdata.

As described above, the variable voltage VD is applied to the source of the drive transistor 22, and the drain thereof is connected to the anode of the organic EL element 25. The cathode of the EL element 25 is connected to the common electrode Vcom. Thus, the current Id flowing through the drive transistor 22 is proportional to VD-Vdata, and the EL element 25 emits light with luminance corresponding to the data signal voltage DP and the source voltage VD of the drive transistor 22.

Next, the operation of adjusting peak luminance (white luminance) according to the brightness of the entire screen of video data will be described.

The average luminance calculating unit (APL calculating unit) 17 calculates an average luminance of the screen, i.e., APL (Average Picture Level) that is the brightness of the entire screen from the input video data (display data). The method of calculating the average luminance (APL) may be to add together the data to take the average of them where the input video data is digital data, or to integrate it where the input video data is an analog signal. Then, the calculated APL is supplied to the drive voltage source (PS) 16.

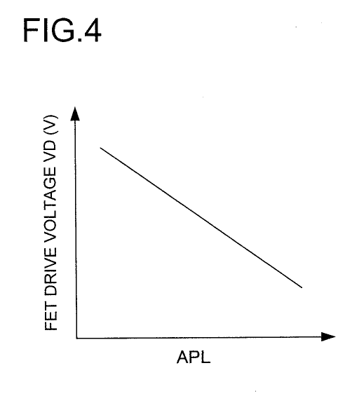

FIG. 4 is a graph showing schematically a relationship of the drive voltage VD of the drive transistor 22, that is, the drive voltage (source voltage) VD in this embodiment against the calculated APL value. The drive voltage source (PS) 16 adjusts the drive voltage (i.e., source voltage) VD of the drive transistor 22 according to the calculated APL value. Namely, the drive voltage source (PS) 16 functions as a drive voltage adjuster. The drive voltage source (PS) 16 adjusts the variable voltage VD to be larger when the entire screen is dark, i.e., the APL is small, and to be smaller when the entire screen is bright with the APL being large.

That is, as described above, because a current (drive current Id) proportional to VD-Vdata flows through the drive transistor 22, the adjustment of the drive voltage VD can impart a peak luminance characteristic where white luminance is made low when video whose entire screen is bright is displayed and becomes higher for video whose background is darker.

Next, the fact that reduction in electric power consumed in the drive transistor 22 together with the peak luminance characteristic can be achieved by adjusting the drive voltage VD according to the brightness (APL) of the entire screen of video data to impart the peak luminance characteristic, will be described specifically with reference to the drawings.

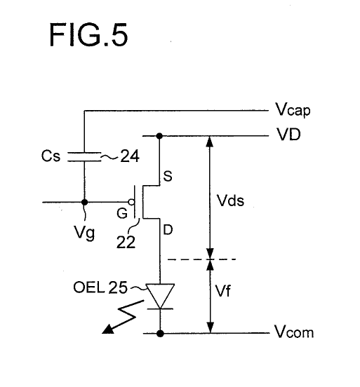

An EL element such as the organic EL element 25 exhibits a diode characteristic as well known. That is, the higher the emission luminance is (or the larger the drive current is), the higher the forward voltage (Vf) is (see FIG. 5). In the conventional configuration, the drive voltage (source voltage) of the drive transistor is fixed, and hence the drive voltage is set according to the highest peak luminance. With this conventional configuration, white luminance is made low when video whose entire screen is bright is displayed, and hence the forward voltage (Vf) of the EL element becomes lower, while power consumed by the drain-source voltage Vds of the drive transistor 22 increases because the drive voltage (source voltage) of the drive transistor 22 is constant.

In contrast, as described above, in the present embodiment the drive voltage (source voltage) VD of the drive transistor 22 is adjusted according to the APL. Specifically, when video whose entire screen is bright is displayed, i.e., when the APL is large, the drive voltage VD is decreased, and thus power consumed corresponding to the drain-source voltage Vds of the drive transistor 22 can be suppressed to a low level.

### Second Embodiment

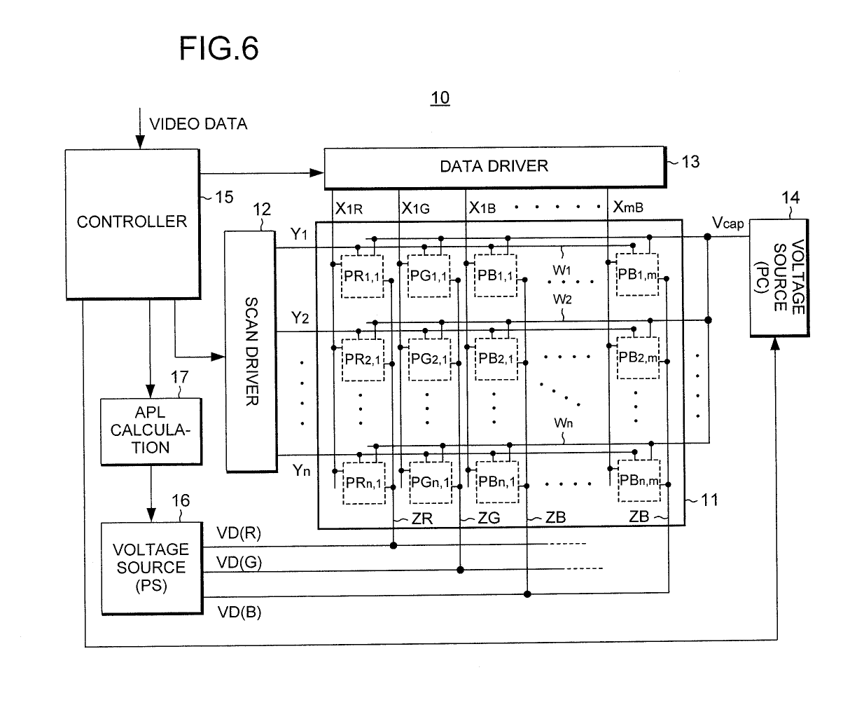

FIG. 6 shows a display apparatus 10 using an active matrix display panel according to a second embodiment of the present invention. In this display apparatus 10, the display panel 11 is configured as a color organic EL panel.

More specifically, three pixel units of red, green, blue (R, G, B) are arranged sequentially in a repeated pattern in a row direction. That is, the three pixel units of red, green, blue (R, G, B) form one pixel, and a plurality of the pixels are arranged in a row direction. More specifically, pixels (PR_{j,1}, PG_{j,1}, PB_{j,1}), (PR_{j,2}, PG_{j,2}, PB_{j,2}), . . . , (PR_{j,m}, PG_{j,m}, PB_{j,m}) are sequentially arranged in the j-th row of the display panel 11.

The circuit configurations of the pixel units of red, green, blue (R, G, B) are the same as in the above first embodiment (see FIG. 3) except that EL elements 25 emitting lights of red, green, blue (R, G, B) are respectively used.

In each row, the red pixel units PR_{j,k} (k=1 to n) are connected to a common connection line ZR, and the green pixel units PG_{j,k} (k=1 to n) are connected to a common connection line ZG, and the blue pixel units PB_{j,k} (k=1 to n) are connected to a common connection line ZB. More specifically, the connection lines ZR, ZG, ZB are connected to the source of the drive transistor (Tr2) 22 in respective pixel units. Drive voltages VD(R), VD(G), VD(B) are supplied respectively onto these connection lines (light-emitting element drive voltage lines) ZR, ZG, ZB from the light-emitting element drive voltage source (PS) 16. Of course, the light-emitting element drive voltage source (PS) 16 may be formed of individual variable voltage sources PS16(R), PS16(G), PS16(B) for the respective colors.

In the present embodiment, the light-emitting element drive voltage source (PS) 16 adjusts each of the drive voltages VD(R), VD(G), VD(B) according to the brightness (APL) of the entire screen of video data. That is, also where the forward voltage is different for each emission color, power consumed by the drive transistor can be reduced. Further, where the forward voltage of the EL element is different for each emission color, by adjusting the drive voltage of the drive transistor for each emission color, the EL element can be driven with a minimum power supply voltage required, and hence the effect of reducing power consumption is larger.

### Third Embodiment

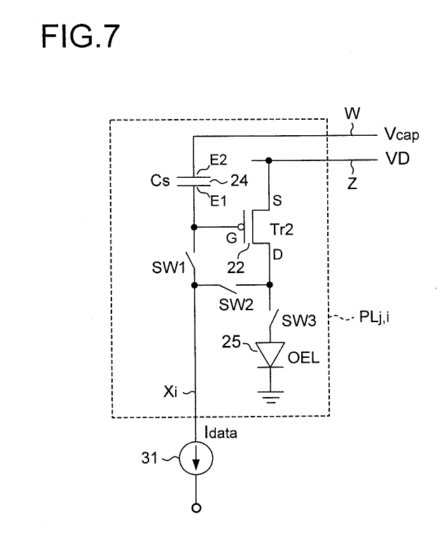

An embodiment which uses a current program scheme will be described below. FIG. 7 shows a pixel unit PL_{j,i} connected to data line Xi (i=1, 2, . . . , m) and scan line Yj (j=1, 2, . . . , n) from among a plurality of pixel units of a display panel 11 according to a third embodiment of the present invention. Note that in this embodiment, description will be made taking as an example the case where the display panel 11 is a monochrome display panel and where each of the pixel units constitutes one pixel.

The configuration of the display apparatus 10 is the same as that in the first embodiment (FIG. 2) except that the data driver 13 and the pixel unit PL_{1,i} have circuit configurations adapted for the current program scheme as described later.

The display panel 11 has a circuit configuration adapted for the current program scheme as shown in FIG. 7. More specifically, the pixel unit PL_{j,i} comprises a drive transistor (Tr2) 22, a capacitor (Cs) 24, a current source 31, and switches SW1 to SW3. The data driver 13 is configured as a constant current source, and the pixel unit PL_{j,i} is supplied with a data current Idata from the current source 31 corresponding to the data line Xi of the data driver.

As in the first embodiment, the source of the drive transistor (Tr2) 22 is connected to the data line Xi, and the second terminal (i.e., electrode E2) of the capacitor (Cs) 24 is connected to a capacitor voltage line W. That is, a capacitor voltage Vcap (a fixed voltage) is applied to the capacitor (Cs) 24 from a capacitor voltage source 14 via the capacitor voltage line W. Although during the period of a write mode of the current program operation, the drive voltage (source voltage) VD of the transistor (Tr2) 22 is made to be a constant (or fixed) voltage as described later, the fixed voltage VD may be the same in value as the capacitor voltage Vcap applied to one end of the data-holding capacitor, or may be different from it.

FIG. 7 shows an example of the pixel circuit configuration of a four-transistor (4-Tr) current program scheme. The current program scheme will be briefly described below. In the current program scheme, the pixel circuit can be set in a write mode and a light-emission mode.

The switches SW1 to SW3 are made open and closed according to a scan pulse signal from the scan driver 12 and/or a control signal from the controller 15. More specifically, their ON/OFF is controlled depending on the write mode of writing data to the capacitor (Cs) 24 or the light-emission mode of making the light-emitting element (OEL) 25 emit light.

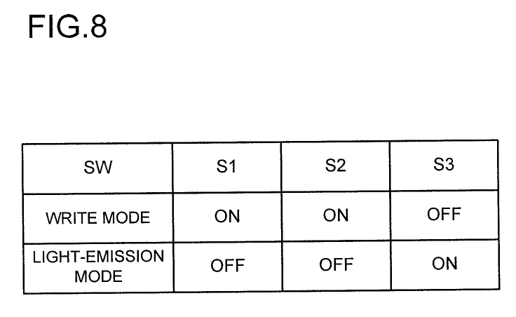

FIG. 8 shows the ON/OFF states of the switches SW1 to SW3. First, in the data write mode, the switches SW1, SW2 are closed (ON) in response to the scan control signal to select the j-th scan line Yj with the switch SW3 being opened (OFF). Thereby, the data current Idata is supplied into the data line Xi to write data. Namely, charge corresponding to a voltage Vcap-Vdata is stored in the capacitor 24 due to the supply of the data current Idata, and this voltage is held across the capacitor. At this time, because the switch SW3 is OFF, the light-emitting element (OEL) 25 does not emit light.

Then, the pixel circuit switches to the light-emission mode, where the switches SW1, SW2 are made open (OFF) with the switch SW3 being closed (ON), and during the light-emission mode period, the drive voltage (source voltage) is set at an adjusted voltage value VD. Namely, the drive voltage source (PS) 16 sets the drive voltage (source voltage) VD to correspond to the APL value calculated by the APL calculating unit 17 and outputs this voltage.

That is, as in the previously-described embodiment, the variable voltage VD is adjusted such that the VD is increased when the entire screen is dark, i.e., when the APL is small, and that the VD is decreased when the entire screen is bright and the APL is large.

Namely, because a current (drive current Id) proportional to VD-Vdata flows through the drive transistor 22 as described above, the adjustment of the drive voltage VD can impart the peak luminance characteristic where white luminance is made low when video whose entire screen is bright is displayed and becomes higher for video whose background is darker.

Thus, as described above, the adjustment drive of the drive voltage VD can be applied to the display apparatus of the current program scheme as well, and the same peak luminance characteristic as in the voltage write type of display apparatus described in the above embodiments can be imparted.

### Fourth Embodiment

Although in the above embodiments description has been made taking as an example the case where the selecting transistor (Tr1) 21 and the drive transistor (Tr2) 22 are P-channel TFTs, the adjustment drive of the drive voltage VD can also be applied to cases where either or both of the two transistors are N-channel TFTs. For example, it can also be applied to cases where the drive transistor (Tr2) 22 is an N-channel TFT.

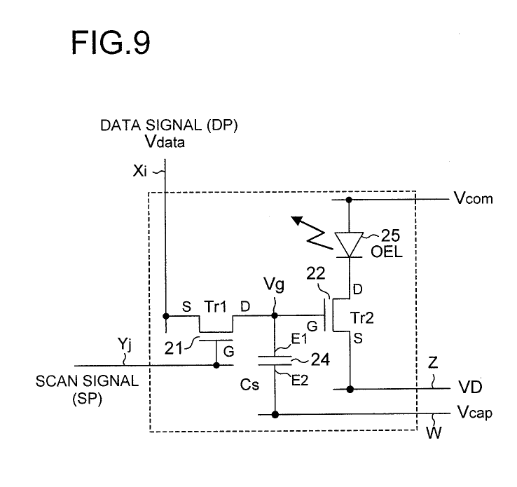

FIG. 9 shows a pixel unit associated with data line Xi (i=1, 2, . . . , m) and scan line Yj (j=1, 2, . . . , n) from among a plurality of pixel units (pixel circuits) PL_{1,1} to PL_{m,n} of a display panel 11. That is, the pixel unit is connected to the data line Xi and the scan line Yj, and more specifically, comprises TFTs (thin film transistors) 21, 22 that are respectively a selecting transistor (Tr1) and a drive transistor (Tr2), a data-holding capacitor (Cs) 24, and an organic EL (electroluminescent) light-emitting element (OEL) 25. The selecting transistor 21, the drive transistor 22, and the capacitor 24 form a drive circuit for the light-emitting element (EL element) 25.

The gate of the selecting transistor (Tr1) 21 is connected to the scan line Yj, and its source is connected to the data line Xi. The drain of the selecting transistor 21 is connected to the control electrode (gate) of the drive transistor (Tr2) 22. The drive transistor (Tr2) 22 is an N-channel TFT, and the source of the drive transistor (Tr2) 22 is connected to a drive voltage line Z so that a drive voltage VD is supplied thereto from the drive voltage source (PS) 16. The drain of the drive transistor (Tr2) 22 is connected to the cathode of the EL element 25. The anode of the EL element 25 is connected to a potential Vcom common to the plurality of pixel units (pixel circuits) PL_{1,1} to PL_{m,n}.

In the present embodiment, one end of the capacitor (Cs) 24 (a first terminal; electrode E1) is connected to the gate, that is the control electrode, of the drive transistor 22 (and to the drain of the selecting transistor 21), and the other end thereof (a second terminal; electrode E2) is connected to the capacitor voltage source (PC) 14 via the capacitor voltage line W. The connection is made such that a capacitor voltage Vcap (a fixed voltage) is applied to the capacitor (Cs) 24 associated with the scan line Yj from the capacitor voltage source (PC) 14 via the capacitor voltage line W.

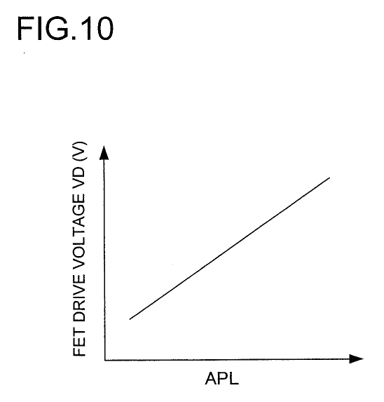

In the present embodiment, as shown in FIG. 10, the drive voltage VD of the drive transistor 22 is adjusted according to the APL. Specifically, the drive voltage VD is increased when video whose entire screen is bright is displayed, i.e., when the APL is large, and thus power consumed corresponding to the drain-source voltage Vds of the drive transistor 22 can be suppressed to a low level.

### Fifth Embodiment

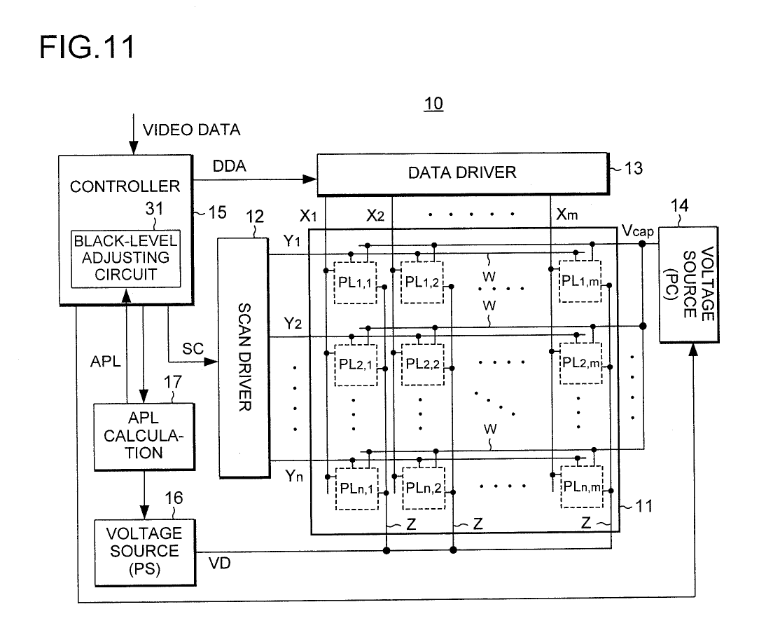

In the present embodiment, as shown in FIG. 11, the display panel 11 is provided with a black-level adjusting circuit 31. The configuration of pixel unit PL_{j,i} of the display panel 11 is the same as in the first embodiment (FIG. 3).

It is more effective to vary video data according to the APL with adjusting the drive voltage VD according to the brightness (APL) of the entire screen of the video data as described in the first embodiment.

The APL value calculated by the APL calculating unit is supplied to the black-level adjusting circuit 31. The black-level adjusting circuit 31 adjusts the black level BL of the input video signal according to the calculated APL value to generate an adjusted data control signal DDA, which is supplied to the data driver 13.

The black-level adjusting circuit 31 may adjust, for example, the gain of an amplifier (not shown) amplifying the input video data when the input video data is an analog signal to generate the adjusted data control signal DDA, and may adjust the gain of a multiplier (not shown) multiplying the input video data by a multiplier factor when the input video data is digital data to generate the adjusted data control signal DDA.

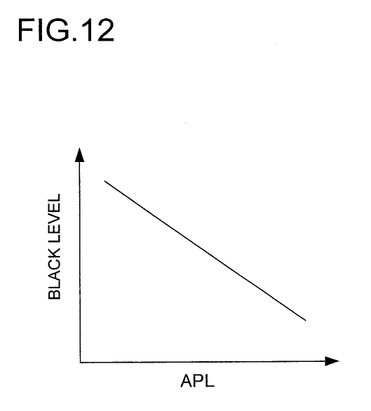

FIG. 12 shows a relationship of the black level voltage BL against the APL value. The black level voltage BL is adjusted such that when the entire screen is dark, i.e., when the APL value is small, the BL is increased, and that when the entire screen is bright and the APL is large, the VD is decreased. By this adjustment, peak luminance processing can be performed with suppressing black floating.

1. A display apparatus which has an active matrix type of display panel comprising a plurality of pixel units each having a light-emitting element and a drive transistor whose drive electrode is supplied with drive voltage driving said light-emitting element, a scan drive unit for sequentially scanning scan lines of said display panel, and a data drive unit for supplying a data signal based on a video signal to a control electrode of each of said drive transistors in association with scanning by said scan drive unit, said display apparatus comprising:
a capacitor provided in each of said plurality of pixel units to hold said data signal, a first terminal of said capacitor being connected to said control electrode of said drive transistor;
a capacitor voltage generating unit which generates a capacitor voltage to be applied to a second terminal of each of said capacitors;
an average luminance calculating unit which calculates average luminance of a display screen based on said video signal; and
a drive voltage adjuster which adjusts the drive voltage driving said light-emitting element of said drive transistors according to said average luminance.

2. A display apparatus according to claim 1, wherein said drive voltage adjuster adjusts said drive voltage such that white luminance of said display screen increases according to decrease in said average luminance.

3. A display apparatus according to claim 1, wherein said display panel is a color light-emitting panel in which a light-emitting element of one color of red, green, and blue is connected between the scan line and the drive line at each of intersections of scan lines and drive lines arranged in a matrix, and said drive voltage adjuster adjusts the drive voltage for said light-emitting elements on a per emission color basis.

4. A display apparatus according to claim 1, wherein said data drive unit comprises a current source that supplies said capacitor with a current corresponding to said data signal.

5. A display apparatus according to claim 1, comprising:
a black-level adjuster that increases a black level for said video signal according to decrease in said average luminance so as to generate said data signal.

6. A display apparatus according to claim 1, wherein the capacitor voltage to be applied to the second terminal of each of said capacitors is a fixed voltage.
